(19) United States
(12) Patent Application Publication
(10) Pub. No.: US 2016/0102697 A1
(43) Pub. Date: Apr. 14, 2016

(54) BOLTED CONNECTION

(71) Applicant: SG Holding UG, Ronnenberg (DE)

(72) Inventor: Harald Goettlich, Wedemark (DE)

(21) Appl. No.: 14/510,146

(22) Filed: Oct. 9, 2014

(51) Int. Cl. F16B 13/14

(52) U.S. Cl. CPC F16B 13/142

(57) ABSTRACT

A bolted connection for a recess in a ground that is delimited by an inside wall surface includes a bolt configured to be disposed in the recess. A curable substance configured to be disposed in an annular gap between the bolt and the inside wall surface of the recess is useable to fix the bolt in the ground. The substance has a viscosity which is sufficiently low to cause the substance to not only spread into the annular gap, but also to penetrate the ground surrounding the annular gap.

### FIELD

The invention relates to a bolted connection comprising at least one bolt which can be fixed in the ground by a curable substance, the substance being introduced into an annular gap between the bolt and an inside wall surface delimiting a recess which is configured, in particular, as a drilled hole.

### BACKGROUND

EP 0 955 476 A2 discloses a self-cutting bolt for use in solid building materials. To fix the bolt, the drilled hole is filled with a curable compound in an annular gap between a wall of the drilled hole and the bolt, the bolt partly cutting into the wall of the drilled hole by its thread.

Furthermore, DE 198 20 671 A1 discloses a bolt which is used in particular for securing items to concrete foundations. To achieve both a low screw-in torque and a high pull-out resistance, the bolt is screwed into a drilled hole with a curable compound. In this respect, the flank of the thread partly penetrates the surrounding foundation, so that a low screw-in torque is required. After curing, the thread is embedded partly in the solid building material and partly in the cured compound. This provides a high pull-out resistance.

DE 199 44 602 A1 discloses a bolt which is inserted into a drilled hole in a solid but porous material, in particular concrete. A cartridge is inserted beforehand into the drilled hole and then the thread-cutting bolt is screwed therein. As a result, a curable compound contained in the cartridge is pressed radially outwards under pressure into the surrounding material in a channel formed between the wall of the drilled hole and the core of the bolt.

DE 103 11 471 A1 relates to a thread-forming bolt for hard, solid building materials, the thread of the bolt partly extending over the length of the bolt shaft and the bolt being screwed into a drilled hole with a curable compound.

A threaded rod or anchor rod is known from EP 0 199 671 B1 which describes the use of cartridges when fastening anchor rods of this type in drilled holes. The curable compound used here consists of a two-component system based on acrylic resin.

### SUMMARY

In an embodiment, the present inventions provides a bolted connection for a recess in a ground that is delimited by an inside wall surface. A bolt is configured to be disposed in the recess. A curable substance configured to be disposed in an annular gap between the bolt and the inside wall surface of the recess is useable to fix the bolt in the ground. The substance has a viscosity which is sufficiently low to cause the substance to not only spread into the annular gap, but also to penetrate the ground surrounding the annular gap.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a part-sectional side view of a bolted connection;

FIG. 2 shows the bolted connection illustrated in FIG. 1 in a damaged drilled hole, partly filled with debris;

FIG. 3 is a side view of a base plate of the foot of a mast with a plurality of bolted connections arranged over the periphery; and

FIG. 4 is a plan view of the base plate shown in FIG. 3.

### DETAILED DESCRIPTION

The present invention recognizes that none of the bolts described above and known from the state of the art is suitable for drilled holes of an undetermined condition and shape which particularly happens in practice when a bolt which has been previously fixed in the hole has forcefully broken out of the foundation, for example due to relatively long-lasting alternating stresses, or when the hole has been damaged in another way, for example even before a bolt has been inserted for the first time, or has been impaired by pitting corrosion. In such cases, inside wall surfaces result which do not allow a defined cut-in action, but instead are typically rutted and interfused by cracks.

It would be possible to machine the drilled hole appropriately before a new bolted connection is fitted to thus produce a shape which is as cylindrical as possible. However, enlarging or additionally deepening the drilled hole is often ruled out.

Moreover, fragments and particles prove to be disadvantageous for the stress- bearing capacity of the connection, so that the hole has to be cleaned of such residues in accordance with the relevant processing specifications.

Mortar cartridges on the market which have already been pre-portioned and have an injection mortar are described as an economical solution for single use and in this case a cleaning procedure of the drilled hole is said to be unnecessary. While there should be a reduced accumulation of dust and dirt and it should be possible to dispense with a suction-removal procedure, the present invention recognizes that the mortar cartridges have a number of disadvantages and are not particularly suitable for drilled holes of an undetermined of unknown condition.

In an embodiment, the present invention makes it possible to produce a reliable bolted connection even in drilled holes of an undetermined or unknown condition, particularly holes with cracks, residues or particles. In particular, the bolted connection producible thus should be fault-tolerant with respect to different penetration depths of the thread pitches into the ground.

Thus, according to an embodiment of the invention, a bolted connection is provided in which the curable substance has such a low viscosity that it spreads not only into the annular gap but it also penetrates, for example diffuses, into the ground surrounding the annular gap. Several advantageous effects can be achieved in this way. First of all, after curing, the volume of the annular gap and the volume of the ground penetrated by the substance form a unit, thereby providing a much greater anchorage volume. In this respect, the substance can flow or sink downwards in the surrounding ground and it also arrives back in the annular gap. Consequently, a reliable filling of the entire annular gap is even ensured when the passage along the cutting edges of the bolt is blocked by debris, for example. Furthermore, the substance includes in an emulsion-like manner the particles which may be present in the recess, thereby providing a sustainable bond. In addition, after curing, the volume penetrated by the substance forms a chemically and physically effective barrier layer so that chemical reactions of the bolt material with constituents of the ground or reactions due to other environmental influences are avoided. In particular, corrosion of the bolt is effectively prevented thereby. It is also ensured that the bolt is always surrounded by a sufficient volume of the substance in all regions of its longitudinal extent and is protected thereby.

Since the bolt including the thread and the core is completely covered by the curable substance and, due to the low viscosity, an adequate and reliable moistening of the surface of the bolt is ensured, the thread pitches do not rest directly against ground which has not been impregnated by the substance in any area of the drilled hole. Instead, the curable substance sheaths the thread pitches with the result that the substance forms in radially exposed regions of the drilled hole an undercut into which the substance radially penetrates the ground. Since the thread pitches of the bolt are thus supported against the substance which, due to its low viscosity, spreads optimally into the cracks and exposed areas, penetrates inside fissures and cures therein, the regions of the ground forming the inside wall surface, combine to form a unit and the stress-bearing capacity of the bolted connection is substantially increased thereby. For this purpose, the fixing forces transmitted by the bolt are distributed over a relatively large volume.

In contrast thereto, the cutting of a thread pitch into the inside wall surface as done in the prior art results in said surface splitting and, particularly in the case of pre-damaged, cracked or loose constituents, leads to the separation of regions with the result that they can no longer absorb any stress. Instead, the remaining topography of the inside wall surface is further removed until a viable engagement is no longer possible.

Furthermore, the arrangement according to an embodiment of the invention makes very low demands on the surface quality of the recess receiving the bolt, in particular on the strength or porosity of the ground. Consequently, the bolt is also suitable for non-form-bound foundations, for example also for soil and pourable and flowable materials because, due to its adhesive forces, the curable substance is capable of forming a bond and thereby a fixed volume, thus, in particular, a foundation.

In contrast thereto, the curable substances known from the prior art are not capable of binding foreign substances. Instead, in the prior art, inclusions of foreign bodies result in a considerable reduction in the stress-bearing capacity, as a result of which the increase in retaining force achievable by the curable substance in the prior art is correspondingly low.

Furthermore, it has been found that due to the bond obtained thus, alternating stresses in particular can be absorbed much more effectively, because the bound volume has much more sluggish characteristics in respect of vibrations due to the bond produced by the curable substance. In addition, the high mass counteracts vibrations in a damping manner.

The substance according to an embodiment of the invention preferably has a greater viscosity and/or density compared to water and is not soluble in water. This substantially simplifies the process of fixing the earth or ground anchor in that the substance automatically easily displaces the water present in the surrounding soil or ground due to its higher viscosity and/or density. In this respect, it is possible to dispense with the previous supply of compressed air. Instead, according to the invention it is possible to produce a very great strength even in water-saturated ground in that the water-insoluble substance provides the necessary free space by displacement without further auxiliaries or supporting measures.

The viscosity is so low that the binder is automatically mixed and in so doing, encompasses the soil particles and possible drilling dust is absorbed. Furthermore, according to an embodiment of the invention, it has proved to be very advantageous that the displacement progresses substantially concentrically with the longitudinal axis of the ground anchor, so that the ground anchor fixed thus can be equally stressed in all directions. Thus in practice a pyriform distribution of the applied substance is preferably produced without further measures.

In addition, it is advantageous that the substance can be used without a pre-treatment of the ground, so that it is possible to dispense with a reaction partner in the ground. In particular, the substance thus cures completely in any type of known ground, also in sandy ground or in other pourable or flowable solids, including debris which may be present, such as drilling dust, even after a short time without adding further reaction partners in the ground. Unlike mortar or cement, for example, the substance binds the ground to form a mushroom-shaped mass clump with a large horizontal effective area.

It is also particularly advantageous if the substance has as a substantial proportion an epoxy-based two-component adhesive, the components being mixed outside the recess or when the liquid is introduced into the recess and therefore can be supplied as a mixture. In this respect, a pre-treatment of the ground or the use thereof as a chemical reaction partner does not apply. A fundamental constituent of the substance can be polyester, polyacrylate and/or epoxide. The viscosity of the substance can be between 150 mPa·s and 600 mPa·s.

The compressive strength achievable thus is substantially higher than the compressive strength of a standard concrete and is comparable with high-strength concrete.

Particularly preferably, the substance has hydrophobic characteristics, thereby substantially promoting the displacement of the liquid present in the soil. Of course, depending on the nature of the soil, particular characteristics of the substance can also be produced to support or prevent a reaction with substances which are present.

Since after the production of the recess intended for the bolted connection, the substance is introduced therein and the bolt is then tightened in the recess, at least portions of which are filled with the substance, and consequently the substance is partly displaced into the adjoining ground, a softening of the soil can be achieved in a particularly advantageous manner since the substance penetrates the ground. Therefore, in the case of deep drilled holes, the bolt can be easily screwed in without great resistance and with low torque.

Since, according to a particularly promising embodiment of the invention, a plurality of bolts is arranged in the ground adjacently to one another along an annularly closed line, the adjacent bolts can be arranged in a spacing from one another in which the substance, introduced into the recesses for the respective bolt, of adjacent recesses merges. This makes it possible for the first time for the substance, radially penetrating the ground from each individual hole, to merge with the substance emanating from the adjacent drilled holes and thus a closed structure joining all the holes is produced. A structure of this type, completely unknown hitherto, allows much higher forces to be transmitted than would have been expected by the sum of the individual bolted connections alone. It is easy to understand that a structure of this type as a volume of the ground penetrated by the substance, is not possible with a curable substance according to the prior art, because these have expansions which are always restricted to the annular gap and therefore the holes cannot be joined together.

It has also been found that the merging of the volumes of substance only in a relatively deep plane of the ground, remote from the bolt heads is completely sufficient for the high stress-bearing capacity and, for example, complete penetration or saturation of the ground would not be necessary.

In this respect, the substance also satisfies strict requirements made in respect of environmental compatibility. Furthermore, the invention is not restricted to a ground in the narrower sense, but can also be used on bulk material stockpiles or under water, for example in connection with offshore constructions.

As used herein, the term “drilled hole” is to be understood as meaning any substantially cylindrical or rotationally symmetrical recess irrespective of the nature of the introduction thereof into the soil. Furthermore, the term “bolted connection” is also to be understood as any form of ground anchor or floor anchor, irrespective of the nature of the surrounding natural or artificial ground.

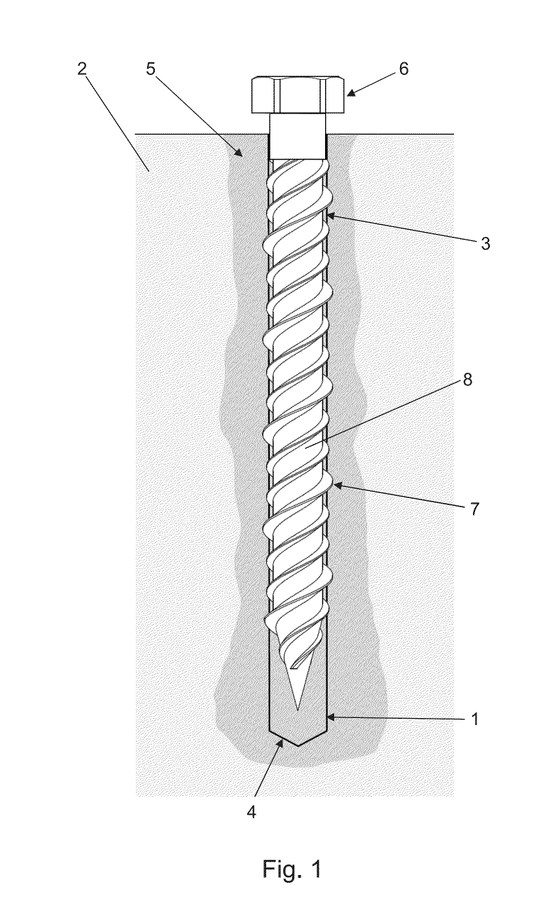

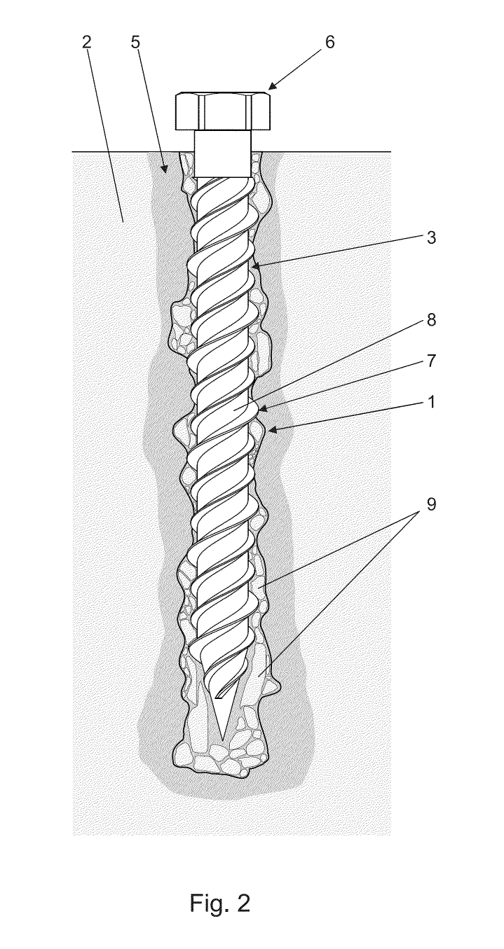

FIGS. 1 and 2 respectively show a bolted connection consisting of a bolt 6 which is fixed in solid ground 2 by means of a curable substance 5. In this respect, the substance 5 not only fills an annular gap 3 between the bolt 6 and an inside wall surface delimiting the recess 1. In fact, due to its low viscosity, the substance 5 penetrates the ground 2 surrounding the annular gap 3. Since the viscosity and density of the water-insoluble substance 5 is greater than water, the substance therefore displaces the moisture which may be present in the ground 2. Consequently, the substance 5 can be used without the ground 2 having been pretreated and it also reliably fills the entire annular gap 3 between the bolt head and the base 4 of the drilled hole. Particularly suitable for this purpose are compositions of substance 5 as an epoxy-based two-component adhesive. The cutting edges 7 of the bolt 6 and the bolt shaft 8 are simultaneously surrounded by the substance 5 such that they are optimally protected against external influences and possible corrosion and are also optimally protected against acids and alkaline influences.

As can be seen in particular in FIG. 2, particles 9 and debris in the recess 1 or other constituents are also included by the substance 5 in an emulsion-like manner and are combined by being embedded therein to form a curable mass. It is easily understood that the inclusion of the particles 9 in no way diminishes the strength of the connection. In fact, the strength is substantially determined by the volume penetrated by the substance 5 and it even exceeds the compressive strength of concrete.

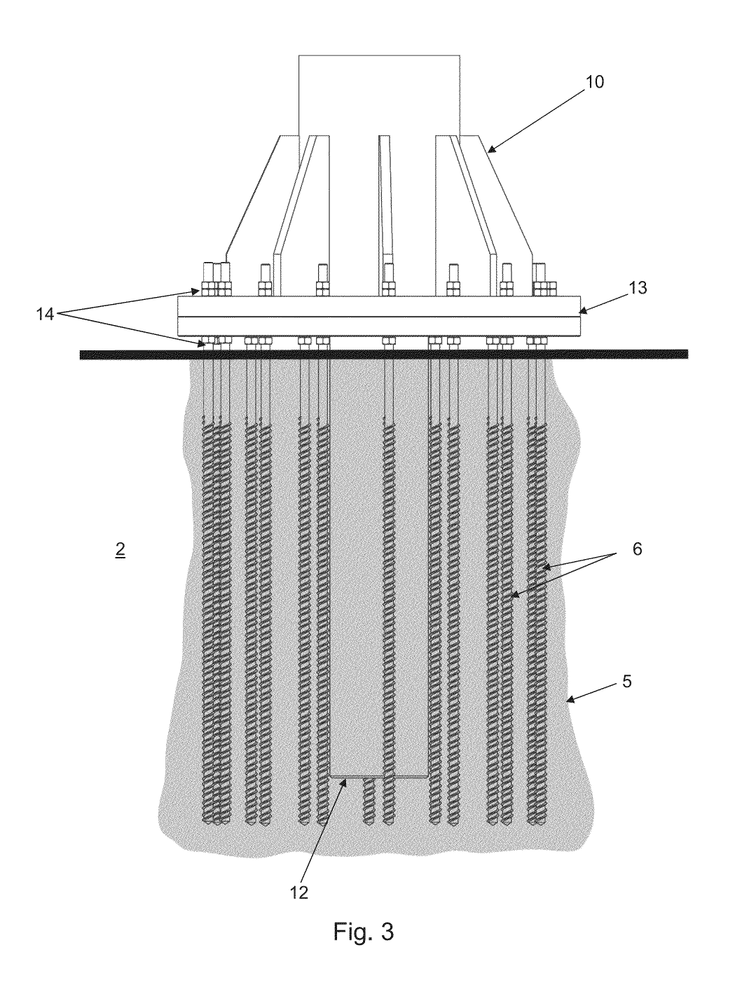

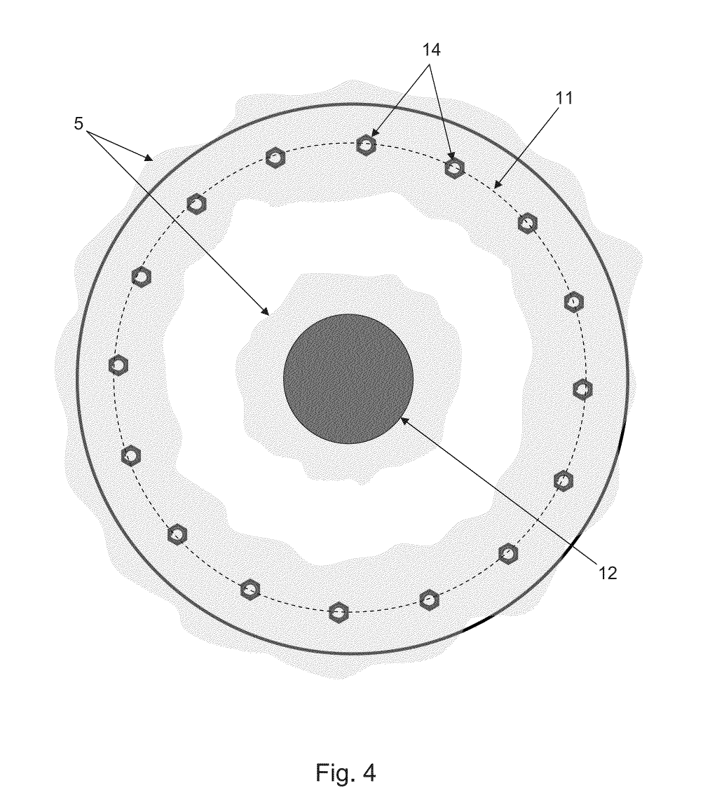

FIGS. 3 and 4 show by way of example a possible use in which a mast foot 10 is secured by the bolted connection to a base plate 13 which, for its part is anchored in the ground 2. As can be seen in FIG. 3, the bolts 6 configured here as threaded pins are arranged adjacently in the ground 2 along an annularly closed line 11 (shown in dashed lines in FIG. 4), the adjacent bolts 6 having a spacing from one another in which the substance 5, respectively introduced into the recesses 1 for the bolts 6, of adjacent recesses 1 combines, coalesces and thus forms a uniformly annularly closed anchorage volume. In addition, a seat 12 extending into the ground 2 for the mast is also fixed in the ground 2 by the same substance 5 to again increase the stress-bearing capacity in the event of flexural loading due to possible wind loads. Since the bolts 6 are configured as threaded pins and the base plate 13 of the mast foot 10 is connected to the thread so as to be adjustable between a plurality of nuts 14, the base plate 13 can be oriented without difficulty, in particular horizontally.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A bolted connection for a recess in a ground that is delimited by an inside wall surface, comprising:
a bolt configured to be disposed in the recess; and
a curable substance configured to be disposed in an annular gap between the bolt and the inside wall surface of the recess, the substance being useable to fix the bolt in the ground,
wherein the substance has a viscosity which is sufficiently low to cause the substance to not only spread into the annular gap, but also to penetrate the ground surrounding the annular gap.

2. The bolted connection according to claim 1, wherein the substance is water-insoluble and has a at least one of a greater viscosity and a greater density than water.

3. The bolted connection according to claim 1, wherein the ground is not pretreated prior to introduction of the curable substance.

4. The bolted connection according to claim 1, wherein a substantial proportion of the substance is an epoxy-based two-component adhesive.

5. The bolted connection according to claim 1, wherein a fundamental constituent of the substance is at least one of polyester, polyacrylate and epoxide.

6. The bolted connection according to claim 1, wherein the substance has hydrophobic characteristics.

7. The bolted connection according to claim 1, wherein the substance has a viscosity of between 150 mPa·s and 600 mPa·s.

8. The bolted connection according to claim 1, further comprising a plurality of the bolts arranged adjacently to each other in a plurality of the recesses in the ground along an annularly closed line, a spacing of the adjacent bolts from one another being such that the substance, respectively introduced into each of the recesses for the bolts, of adjacent recesses is combined.

9. A method for permanently fixing a bolted connection in a recess in a ground, comprising:
after production of the recess intended for the bolted connection, introducing a curable substance into the recess; and then
screwing a bolt of the bolted connection into the recess, at least portions of which are filled with the substance, such that the substance is partly displaced into the adjoining ground.
